(19) United States
(12) Patent Application Publication
(10) Pub. No.: US 2015/0362453 A1
(43) Pub. Date: Dec. 17, 2015

(54) ELECTROCHEMICAL-BASED ANALYTICAL TEST STRIP WITH SOLUBLE ACIDIC MATERIAL COATING

(71) Applicant: LIFESCAN SCOTLAND LIMITED, Inverness (GB)

(72) Inventors: Gavin MACFIE, Inverness (GB); Alexander COOPER, Inverness (GB); Christopher LEACH, Inverness (GB); Stephen MACKINTOSH, Inverness (GB)

(21) Appl. No.: 14/764,427

(22) PCT Filed: Jan. 30, 2014
(86) PCT No.: PCT/GB2014/050257

§ 371 Date: Jul. 29, 2015

(30) Foreign Application Priority Data
Jan. 31, 2013 (GB) 1301747.0

(51) Int. Cl. G01N 27/327

(52) U.S. Cl. CPC G01N 27/3272

(57) ABSTRACT

An electrochemical-based analytical test strip (EBATS) for the determination of an analyte (such as glucose) in a bodily fluid sample (for example, a whole blood sample) includes an electrically insulating base layer (110), a patterned electrically conductive layer (120) disposed on the electrically insulating base layer, an enzymatic reagent layer (140) disposed on the patterned electrically conductor layer, a patterned spacer layer (150), a top layer (170) having an underside surface, and a soluble acidic material coating (160) on the underside surface of the top layer. The patterned spacer layer and top layer define a sample-receiving chamber (180) within the EBATS and the soluble acidic material coating is disposed on the underside surface of the top layer within the sample-receiving chamber. In addition, the soluble acidic material coating is operably dissolvable in the bodily fluid sample such that a pH of the bodily fluid sample in the sample-receiving chamber is reduced during use of the EBATS.

### FIELD OF THE INVENTION

The present invention relates, in general, to medical devices and, in particular, to analytical test strips and related methods.

### BACKGROUND

The determination (e.g., detection and/or concentration measurement) of an analyte in, or a characteristic of, a fluid sample is of particular interest in the medical field. For example, it can be desirable to determine glucose, ketone bodies, cholesterol, lipoproteins, triglycerides, acetaminophen, hematocrit and/or HbA1c concentrations in a sample of a bodily fluid such as urine, blood, plasma or interstitial fluid. Such determinations can be achieved using analytical test strips, based on, for example, visual, photometric or electrochemical techniques. Conventional electrochemical-based analytical test strips are described in, for example, U.S. Pat. Nos. 5,708,247, and 6,284,125, each of which is hereby incorporated in full by reference.

### SUMMARY OF THE INVENTION

In a first aspect, there is provided an electrochemical-based analytical test strip comprising:
an electrically insulating base layer;
a patterned electrically conductive layer disposed on the electrically insulating base layer;
an enzymatic reagent layer disposed on at least a portion of the patterned electrically conductor layer;
a patterned spacer layer;
a top layer having an underside surface; and
a soluble acidic material coating on the underside surface of the top layer;
wherein at least the patterned spacer layer and top layer define a sample-receiving chamber within the electrochemical-based analytical test strip; and
wherein the soluble acidic material coating is disposed on the underside surface of the top layer within at least a portion the sample-receiving chamber; and
the soluble acidic material coating is operably dissolvable in the bodily fluid sample such that a pH of the bodily fluid sample in the sample-receiving chamber is reduced during use of the electrochemical-based analytical test strip.

The soluble acidic material coating may include a surfactant.

The enzymatic reagent layer may include ferricyanide and the bodily fluid sample may be a whole blood sample containing uric acid.

The soluble acidic material coating may be operably dissolvable in the bodily fluid sample such that a pH of the bodily fluid sample in the sample-receiving chamber may be reduced to a pH in the range of pH 4 to pH 6 during use of the electrochemical-based analytical test strip.

The soluble acidic material coating may be operably dissolvable in the bodily fluid sample such that a pH of the bodily fluid sample in the sample-receiving chamber is reduced to a pH of approximately 4 during use of the electrochemical-based analytical test strip.

The top layer, soluble acidic material layer may be integrated as an engineered top tape.

The patterned electrically conductive layer may include a plurality of electrodes disposed in the sample-receiving chamber.

The analyte may be glucose and the bodily fluid sample may be a whole blood sample.

The soluble acidic material coating may include citric acid.

The soluble acidic material coating may include citric acid and tri-sodium citrate.

the citric acid and tri-sodium citrate are formulated as a pH 4 buffer.

The soluble acidic material coating and patterned electrically conductor layer are separated by a vertical distance of approximately 100 microns in the sample-receiving chamber.

A thickness of the soluble acidic material coating may be in the range of 5.8 microns to 17.3 microns.

The soluble acidic material coating may include at least one of acetic acid, maleic acid, formic acid, and lactic acid.

The electrically conductive layer includes at least one working electrode disposed in the sample-receiving chamber and the soluble acidic material coating is disposed in the sample-receiving chamber above the at least one working electrode.

In a second aspect, there is provided a method for determining an analyte in a bodily fluid sample, the method comprising:
introducing a bodily fluid sample into a sample-receiving chamber of an electrochemical-based analytical test strip, the electrochemical-based analytical test strip including:
a top layer with an underside surface; and
a soluble acidic material coating on the underside surface within at least a portion the sample-receiving chamber, and
wherein the introduction is such that the soluble acidic material coating operably dissolves in the bodily fluid sample and reduces a pH of the bodily fluid sample in the sample-receiving chamber;
detecting an electrochemical response of the electrochemical-based analytical test strip; and
determining an analyte in the bodily fluid sample based on the detected analytical response.

The electrochemical-based analytical test strip may further include:
an electrically insulating base layer;
a patterned electrically conductive layer disposed on the electrically insulating base layer;
an enzymatic reagent layer disposed on at least a portion of the patterned electrically conductor layer; and
a patterned spacer layer; and
wherein at least the patterned spacer layer and top layer defines the sample-receiving chamber within the electrochemical-based analytical test strip.

The detecting of an electrochemical response may involve employing a plurality of electrodes of the patterned electrically conductive layer.

The bodily fluid sample may be a whole blood sample containing uric acid.

The analyte may be glucose.

The soluble acidic material coating may include a surfactant.

The enzymatic reagent layer includes ferricyanide and the bodily fluid sample may be a whole blood sample containing uric acid.

The soluble acidic material coating may be dissolved in the bodily fluid sample such that a pH of the bodily fluid sample in the sample-receiving chamber is reduced to a pH in the range of pH 4 to pH 6.

The soluble acidic material coating may include citric acid.

The soluble acidic material coating may include citric acid and tri-sodium citrate.

The citric acid and tri-sodium citrate may be formulated as a pH 4 buffer.

The soluble acidic material coating and patterned electrically conductor layer may be separated by a vertical distance of approximately 100 microns in the sample-receiving chamber.

A thickness of the soluble acidic material coating may be in the range of 5.8 microns to 17.3 microns.

The soluble acidic material coating may include at least one of acetic acid, maleic acid, formic acid, and lactic acid.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention, in which:

FIG. 1 is a simplified exploded perspective view of an electrochemical-based analytical test strip according to an embodiment of the present invention;

FIG. 2 is a simplified perspective view of the electrochemical-based analytical test strip of FIG. 1;

FIG. 3 is a simplified cross-sectional side view of a portion of the electrochemical-based analytical test strip of FIG. 1 taken along line A-A of FIG. 2;

FIG. 4 is a graph depicting the effect of citric acid addition on the pH of a whole blood sample;

FIGS. 5A and 5B are a graph of an electrochemical response of an electrochemical-based analytical test strip according to an embodiment of the present invention versus glucose concentration in an applied whole blood sample and a histogram of the bias of the electrochemical response in comparison to a reference measurement, respectively;

FIGS. 6A and 6B are a graph of electrochemical response of a control electrochemical-based analytical test strip versus glucose concentration in an applied whole blood sample and a histogram of the bias of the electrochemical response in comparison to a reference measurement, respectively;

FIG. 7 is a graph of the bias of an electrochemical-based analytical test strip according to the present invention versus uric acid concentration (i.e., level 0 of 0 mg/dL; level 1 of 5.88 mg/dL and level 2 of 11.75 mg/dL);

FIG. 8 is a graph of the bias of an electrochemical-based analytical test strip according to the present invention versus uric acid concentration (i.e., level 0 of 0 mg/dL; level 1 of 5.88 mg/dL and level 2 of 11.75 mg/dL); and

FIG. 9 is a flow diagram depicting stages in a method for determining an analyte in a bodily fluid sample according to an embodiment of the present invention.

### DETAILED DESCRIPTION OF ILLUSTRATIVE EMBODIMENTS

The following detailed description should be read with reference to the drawings, in which like elements in different drawings are identically numbered. The drawings, which are not necessarily to scale, depict exemplary embodiments for the purpose of explanation only and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein.

In general, electrochemical-based analytical test strips for the determination of an analyte (such as glucose) in a bodily fluid sample (for example, a whole blood sample) according to embodiments of the present invention include an electrically insulating base layer, a patterned electrically conductive layer disposed on the electrically insulating base layer, an enzymatic reagent layer disposed on the patterned electrically conductor layer, a patterned spacer layer, a top layer having an underside surface, and a soluble acidic material coating on the underside surface of the top layer. The patterned spacer layer and top layer define a sample-receiving chamber within the electrochemical-based analytical test strip and the soluble acidic material coating is disposed on the underside surface of the top layer within the sample-receiving chamber. In addition, the soluble acidic material coating is operably dissolvable in the bodily fluid sample such that a pH of the bodily fluid sample in the sample-receiving chamber is reduced during use of the electrochemical-based analytical test strip.

The determination of an analyte in a bodily fluid sample, such as the determination of glucose in a whole blood sample, using electrochemical-based analytical test strips can be susceptible to determination inaccuracies arising from the presence of endogenous and exogenous substances in the blood sample (referred to as interferent compounds or simply “interferents”). Such interferent compounds can give rise to measurement inaccuracies through two mechanisms. Firstly, the interferent compound may be directly oxidized at an electrode surface, giving rise to a direct interference error current. Secondly, the interferent compound may react with a mediator of the enzymatic reagent, giving rise to an indirect interference error current. Uric acid in whole blood samples is one such interferent and can be present at endogenous levels in the range of, for example, 3 mg/dL to 8 mg/dL.

Electrochemical-based analytical test strips according to embodiments of the present invention are beneficial in that, for example, the reduced pH of the bodily fluid sample can serve to reduce the deleterious effect of interferents (such as uric acid in a whole blood sample) on an electrochemical response of the analytical test strip that is employed in the determination. Moreover, the soluble acidic material coating does not increase the volume of the sample-receiving chamber and, due to its disposition on the underside surface of the top layer, does not directly upset the chemical characteristics of an enzymatic reagent layer disposed on the patterned electrically conductor layer. In addition, since the soluble acidic material coating is disposed on the underside surface of the top layer, (i) the soluble acidic material is not in contact with the enzymatic reagent layer, thus preventing any deleterious impact on the enzymatic reagent layer such as, for example, enzyme denaturating, and (ii) during use, the pH of the bodily fluid sample is lowered without exposing the enzymatic reagent layer or dissolved components thereof to an overly aggressive environment.

It is postulated without being bound that embodiments of the present invention are particularly beneficial in regards to the interferent uric acid in a whole blood sample in combination with an enzymatic reagent layer that includes ferricyanide. In that circumstance, a reduced pH results in less of the uric acid being speciated in an electrochemically active monoanion form and also lessened indirect interference between uric acid and ferricyanide. Similar benefits are expected for any interferents for which the mechanism of interference is similar to that of uric acid. Specifically, for those interferents that are speciated at low pH in a manner that is less electrochemically active than at physiological pH and/or less reactive towards an enzymatic reagent layer mediator at low pH than at physiological pH.

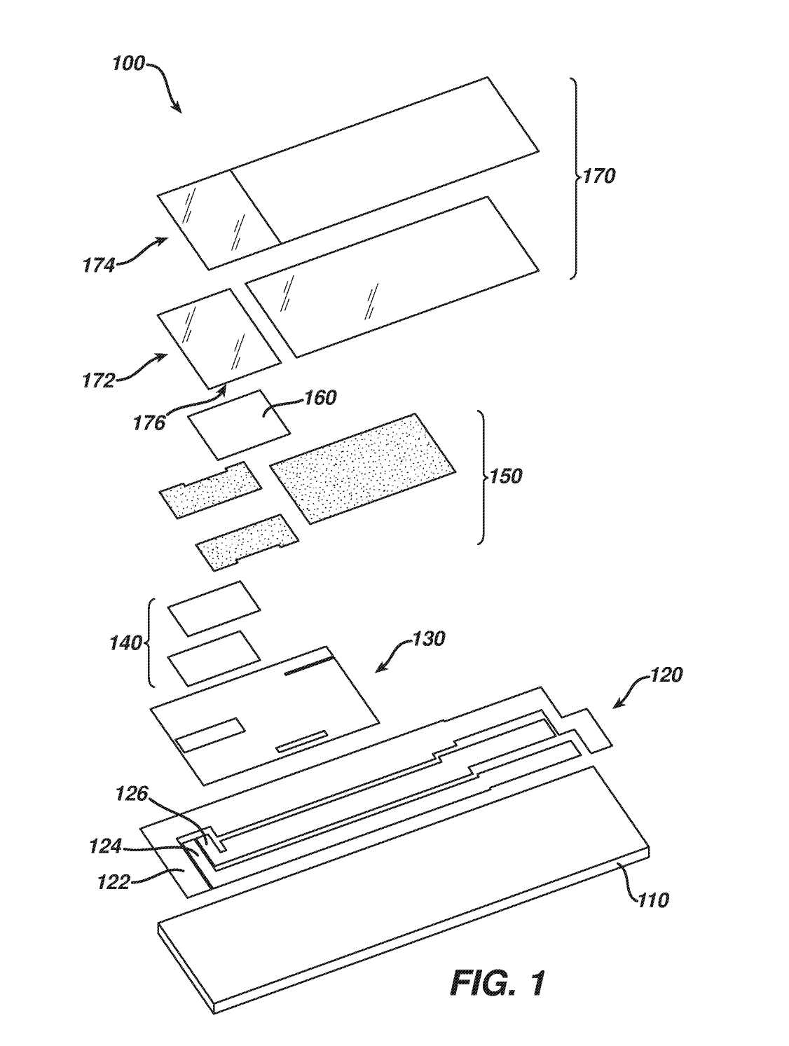

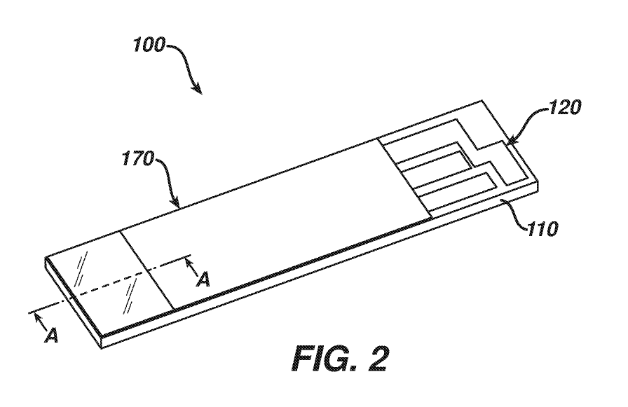

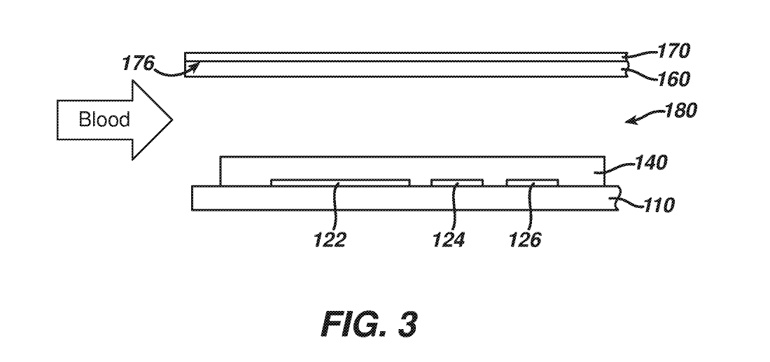

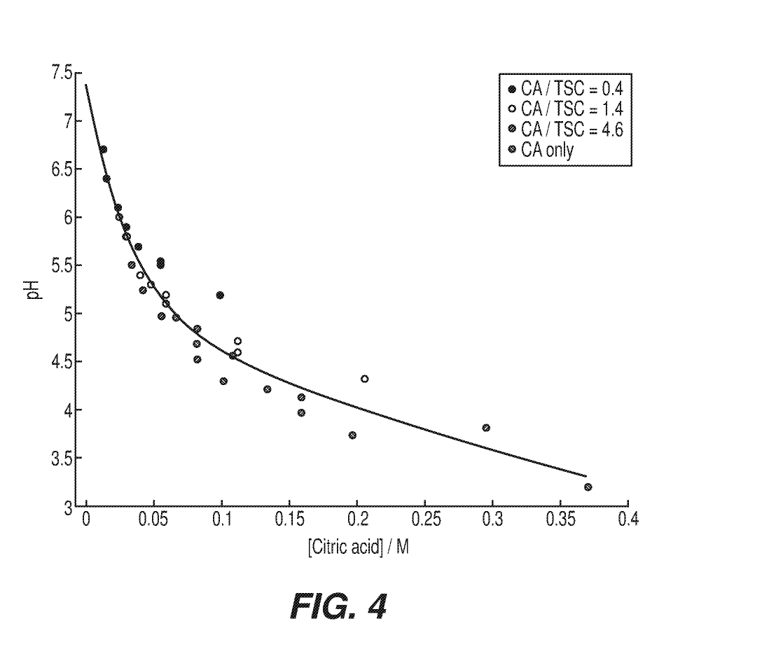

FIG. 1 is a simplified exploded perspective view of an electrochemical-based analytical test strip 100 according to an embodiment of the present invention. FIG. 2 is a simplified perspective view of electrochemical-based analytical test strip 100. FIG. 3 is a simplified cross-sectional side view of a portion of electrochemical-based analytical test strip 100 taken along line A-A of FIG. 2. FIG. 4 is a graph depicting the effect of citric acid addition on the pH of a whole blood sample.

Referring to FIGS. 1-4, electrochemical-based analytical test strip 100 for the determination of an analyte (such as glucose) in a bodily fluid sample (for example, a whole blood sample) includes an electrically-insulating base layer 110, a patterned electrically conductive layer 120, an optional patterned insulation layer 130, enzymatic reagent layer 140, a patterned spacer layer 150, a soluble acidic material coating 160, a top layer 170 consisting of a hydrophilic sub-layer 172 and a top tape 174. Hydrophilic sub-layer 172 of top layer 170 has an underside surface 176 (see FIG. 3 in particular).

In the embodiment of FIGS. 1-4, at least the patterned spacer layer and top layer define a sample-receiving chamber 180 within electrochemical-based analytical test strip 100 (see FIG. 3 in particular where the introduction of a bodily fluid sample (i.e., blood) into sample-receiving chamber 180 is depicted with an arrow).

Electrically-insulating base layer 110 can be any suitable electrically-insulating base layer known to one skilled in the art including, for example, a nylon base layer, a polycarbonate base layer, a polyimide base layer, a polyvinyl chloride base layer, a polyethylene base layer, a polypropylene base layer, a glycolated polyester (PETG) base layer, or a polyester base layer. The electrically-insulating base layer can have any suitable dimensions including, for example, a width dimension of about 5 mm, a length dimension of about 27 mm and a thickness dimension of about 0.5 mm.

Electrically-insulating base layer 110 provides structure to electrochemical-based analytical test strip 100 for ease of handling and also serves as a base for the application (e.g., printing or deposition) of subsequent layers (e.g., a patterned electrically conductor layer).

Patterned electrically conductive layer 120 is disposed on the electrically-insulating base layer 110 and includes a first electrode 122, a second electrode 124 and a third electrode 126. First electrode 122, second electrode 124 and third electrode 126 can be, for example, configured as a counter/reference electrode, working electrode and another working electrode, respectively. Therefore, the second and third electrodes are also referred to herein as working electrodes 124 and 126. Although, for the purpose of explanation only, electrochemical-based analytical test strip 100 is depicted as including a total of three electrodes, embodiments of electrochemical-based analytical test strips, including embodiments of the present invention, can include any suitable number of electrodes.

Patterned electrically conductive layer 120, including first electrode 122, second electrode 124 and third electrode 126, of electrochemical-based analytical test strip 100 can be formed of any suitable conductive material including, for example, gold, palladium, platinum, indium, titanium-palladium alloys and electrically conducting carbon-based materials including carbon inks. It should be noted that patterned electrically conductor layers employed in analytical test strips according to embodiments of the present invention can take any suitable shape and be formed of any suitable materials including, for example, metal materials and conductive carbon materials.

Referring in particular to FIGS. 1 and 3, the disposition of first electrode 122, second electrode 124 and third electrode 126 and enzymatic reagent layer 140 are such that electrochemical-based analytical test strip 100 is configured for the electrochemical determination of an analyte (such as glucose) in a bodily fluid sample (such as a whole blood sample containing the interferent uric acid) that has filled sample-receiving chamber 180.

Enzymatic reagent layer 140 is disposed on at least a portion of patterned electrically conductor layer 120. Enzymatic reagent layer 140 can include any suitable enzymatic reagents, with the selection of enzymatic reagents being dependent on the analyte to be determined. For example, if glucose is to be determined in a blood sample, enzymatic reagent layer 140 can include a glucose oxidase or glucose dehydrogenase along with other components necessary for functional operation. Enzymatic reagent layer 140 can include, for example, glucose oxidase, tri-sodium citrate, citric acid, polyvinyl alcohol, hydroxyl ethyl cellulose, potassium ferricyanide, potassium ferrocyanide, antifoam, fumed silica (either with or without a hydrophobic surface modification), PVPVA, and water. Further details regarding reagent layers, and electrochemical-based analytical test strips in general, are in U.S. Pat. Nos. 6,241,862 and 6,733,655, the contents of which are hereby fully incorporated by reference. It should be noted that the amount of acidic material employed in enzymatic reagents (such as the citric acid and tri-sodium citrate mentioned above) is not sufficient to reduce the pH of a bodily fluid sample to the levels required to provide beneficially reduced interferent effects.

Patterned spacer layer 150 can be formed, for example, from a screen-printable pressure sensitive adhesive commercially available from Apollo Adhesives, Tamworth, Staffordshire, UK. In the embodiment of FIGS. 1 through 3, patterned spacer layer 150 defines outer walls of the sample-receiving chamber 180. Patterned spacer layer 150 can have a thickness of, for example, approximately 75 microns, be electrically nonconductive, and be formed of a polyester material with top and bottom side acrylic-based pressure sensitive adhesive.

Soluble acidic material coating 160 is disposed on the underside surface 176 of hydrophilic sub-layer 172 of top layer 170 within at least a portion of sample-receiving chamber 180 such that soluble acidic material coating 160 is disposed above at least working electrodes 124 and 126. Moreover, soluble acidic material coating 160 is operably dissolvable in the bodily fluid sample such that a pH of the bodily fluid sample in the sample-receiving chamber is reduced during use of the electrochemical-based analytical test strip.

Referring to FIG. 4 in particular, it has been determined that the pH of a whole blood sample can be reduced to approximately pH 3, provided that sufficient citric acid is present in a sample-receiving chamber. FIG. 4 depicts the effect of adding citric acid (CA) on blood pH for a pH 5 citrate buffer (CA/TSC=0.4), a pH 4 citrate buffer (CA/TSC=1.4), pH 3 citrate buffer (CA/TSC 4.6) and citric acid only (CA). The addition of around 0.25M citric acid reduces the pH of the blood sample below pH 4 (see FIG. 4). A pH of 4 is sufficient to substantially protonate the interferent uric acid in whole blood, rendering the uric acid electrochemically inactive, thus effectively eliminating any interfering reaction between uric acid and ferricyanide that is commonly present in an enzymatic reagent layer. It is noted that the electrochemically inactive form of uric acid does not oxidize at an electrode surface. Moreover, since at low pH the reaction rate between ferricyanide and uric acid is significantly reduced, the amount of ferrocyanide generated by such a reaction and oxidized at the electrode surface is also significantly reduced. Such an addition of citric acid would, therefore, be expected to result in a substantial reduction in the interfering effect of uric acid on the determination of glucose in a whole blood sample that contains uric acid.

Studies of the solution stability of GOD (glucose oxidase) revealed that it is reasonably stable down to pH 3, but that it deactivates rapidly in the presence of ferricyanide at pH 3. Therefore, the amount of soluble acidic material coated on the top layer can beneficially be, for example, sufficient to reduce the bodily fluid sample pH into the range of pH 4 to pH 6. In this pH range, the interfering effect of the uric acid is substantially reduced compared to that at physiological pH due to a reduction in both the concentration of the electrochemically active monoanion of uric acid and the reaction rate between potassium ferricyanide and uric acid to form ferrocyanide. In addition, it can be beneficial for the amount of soluble acidic material in the soluble acidic material coating to be such that the bodily fluid sample pH in the region of the enzymatic reagent layer is not reduced to pH 3, at which point the combination of low pH and presence of ferricyanide can result in the deleterious de-activation of glucose oxidase.

For the purposes of explanation, citric acid was selected as the acidic material for the soluble acidic material coating. However, any suitable acidic material can be employed in embodiments of the present invention as long as it is readily soluble in the bodily fluid sample, diffuses rapidly and does not have any detrimental effect on the enzymatic reagent chemistry. For example, other weak acids such as acetic acid, maleic acid, formic acid or lactic acid could be suitable depending on the analyte, bodily fluid sample and enzymatic reagent layer characteristics.

COMSOL (a commercially available finite element modeling software package) modeling indicates that dissolution and diffusion into the bodily fluid sample of citric acid based soluble acidic material coatings with thicknesses in the range of 5.8 microns to 17.3 microns are effective in beneficially reducing the pH of a whole blood sample. For a 17.3 um thickness, the pH was reduced to below pH 6 throughout a sample chamber below pH within 2 seconds of bodily fluid sample introduction. By 5 seconds, the pH throughout the sample chamber was in the range of pH 3.5 to pH 4.5, sufficiently low to effect a reduction in both the concentration of the electrochemically active monoanion of uric acid and the reaction rate between potassium ferricyanide and uric acid to form ferrocyanide, thus reducing the interfering effect of uric acid. In addition, the pH local to the electrode's surfaces was greater than pH 4, hence no or minimal deactivation of enzyme within the enzymatic reagent layer would be predicted and the glucose response is expected to be unimpaired. Therefore, based on the COMSOL diffusion model, the dissolution of a 17.3 μm thickness soluble acidic material coating would lower the pH throughout the sample chamber sufficiently to effect a reduction in uric acid interference, without deactivating the enzyme to the extent that the glucose sensitivity of the electrochemical-based analytical test strip is compromised.

Top layer 170 can be, for example, a clear film with hydrophilic properties that promote wetting and filling of electrochemical-based analytical test strip 100 by a fluid sample (e.g., a whole blood sample). Such clear films are commercially available from, for example, 3M of Minneapolis, Minn. U.S.A. and Coveme (San Lazzaro di Savena, Italy). Top layer 170 can be, for example, a polyester film coated with a surfactant that provides a hydrophilic contact angle <10 degrees. Top layer 170 can also be a polypropylene film coated with a surfactant or other surface treatment. In such a circumstance, the surfactant coating serves as hydrophilic sub-layer 172. Moreover, if desired, the soluble acidic material coating can be formulated as a hydrophilic coating and also serve as a hydrophilic sub-layer. Top layer 170 can have a thickness, for example, of approximately 100 μm.

Electrochemical-based analytical test strip 100 can be manufactured, for example, by the sequential aligned formation of patterned electrically conductor layer 120, enzymatic reagent layer 140, patterned spacer layer 150, and hydrophilic sub-layer 172 onto electrically-insulating base layer 110. Any suitable techniques known to one skilled in the art can be used to accomplish such sequential aligned formation, including, for example, screen printing, photolithography, photogravure, chemical vapour deposition and tape lamination techniques.

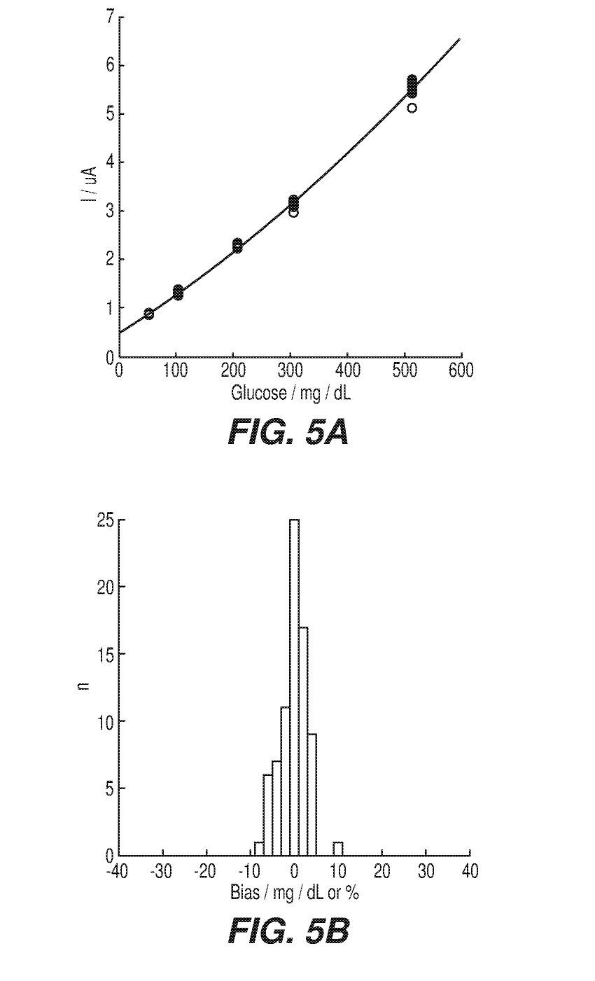

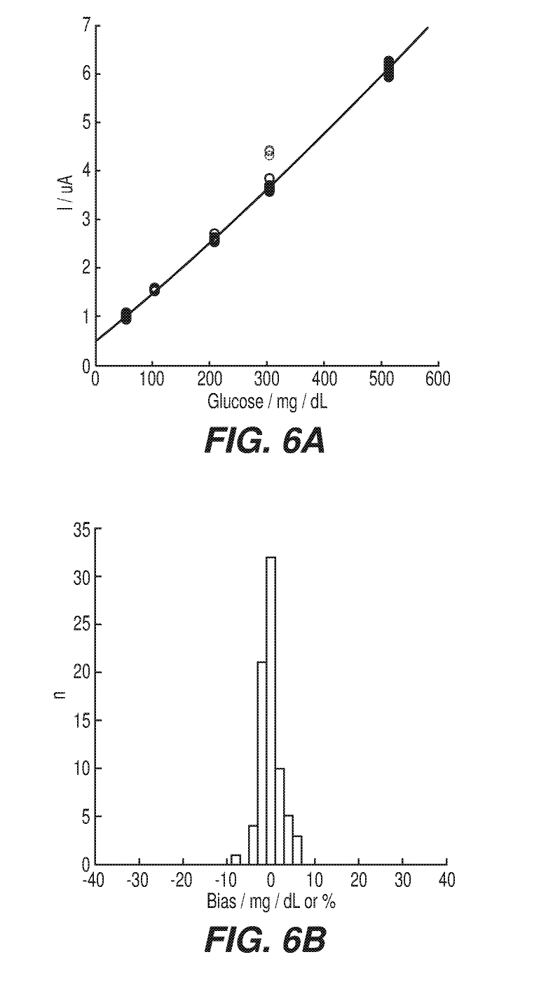

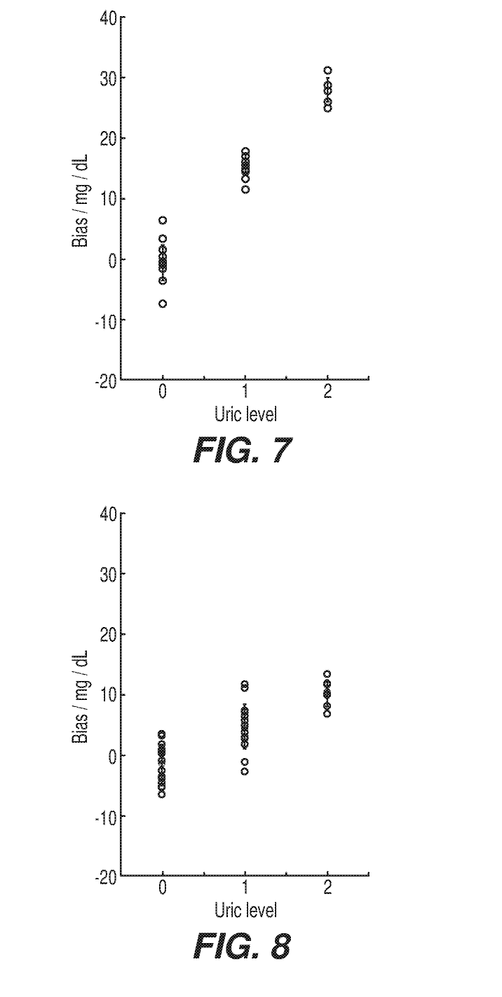

FIGS. 5A and 5B are a graph of an electrochemical response from an electrochemical-based analytical test strip according to the present invention versus glucose concentration in an applied whole blood sample, and a histogram of the bias of the electrochemical response in comparison to a reference measurement, respectively. FIGS. 6A and 6B are a graph of electrochemical response from a control electrochemical-based analytical test strip versus glucose concentration in an applied whole blood sample and a histogram of the bias of the electrochemical response in comparison to a reference measurement, respectively. In FIGS. 5b and 6B, absolute bias is employed for glucose levels below 75 mg/dL and percent bias is employed for glucose levels above 75 mg/dL. FIG. 7 is a graph of the bias of an electrochemical-based analytical test strip according to the present invention versus uric acid concentration (i.e., level 0 of 0 mg/dL; level 1 of 5.88 mg/dL and level 2 of 11.75 mg/dL). FIG. 8 is a graph of the bias of an electrochemical-based analytical test strip according to the present invention versus uric acid concentration (i.e., level 0 of 0 mg/dL; level 1 of 5.88 mg/dL and level 2 of 11.75 mg/dL).

Referring to FIGS. 5A through 8, electrochemical-based analytical test strip according to the present invention were manufactured using citric acid (700 g/L) and tri-sodium citrate (400 g/L) mixed together to generate a concentrated buffer solution with pH 4. Tergitol NP7 (a surfactant) was added (at 0.5%) to increase the wettability of the soluble acidic material coating, and to ensure near-instantaneous dissolution thereof in a bodily fluid sample. It was determined that such near-instantaneous and uniform dissolution resulted in a precision improvement in the case of the formulation with added surfactant when compared to the case without any added surfactant. Further investigations revealed that surfactant concentrations up to 5% can be beneficial in terms of increasing the precision of analyte determination.

The acidic solution was then spray coated onto the underside of a top layer using a Biodot AD3050 spray apparatus at a dispense rate of 1.7 micro-liter per square-cm. Such as dispense rate was calculated, using the bulk densities of citric acid and trisodium citrate, to provide a dried soluble acidic material coating with a thickness of 17.3 μm. The acid-coated top layer thus prepared was then used to manufacture electrochemical-based analytical test strips using standard procedures.

Two lots of electrochemical-based analytical test strips were manufactured. One was prepared as described above and the other as a control in that it did not include a soluble acidic material coating. Both lots were tested with bloods spiked with 500, 100, 200, 300 and 500 mg/dL glucose to characterize their glucose sensitivities. The resulting calibration plots of current at 5 seconds versus glucose concentration and histograms of bias to YSI reference (absolute bias at 50 mg/dL, percent bias at 100, 200, 300 and 500 mg/dL) calculated using these calibration parameters are presented in FIGS. 5A, 5B, 6A and 6B. Comparing the date of FIGS. 6A and 6B, the standard deviation of the bias for the electrochemical-based analytical test strips with a soluble acidic material coating was essentially equivalent to the standard deviation of the bias for the control electrochemical-based analytical test strips given experimental error and the inaccuracies of the methods used to construct the sets of analytical test strips.

The two lots were then tested with whole blood sample spiked with 50 mg/dl glucose and with 5.88 mg/dL and 11.75 mg/dL uric acid. Biases to YSI were determined. These biases are plotted versus uric acid concentration in FIGS. 7 and 8. The increase in mean bias in case the uric acid spiked bloods was much reduced in the case of electrochemical-based analytical test strips according to the present invention (se FIG. 7) as compared to compared to the control electrochemical-based analytical test strips (see FIG. 8).

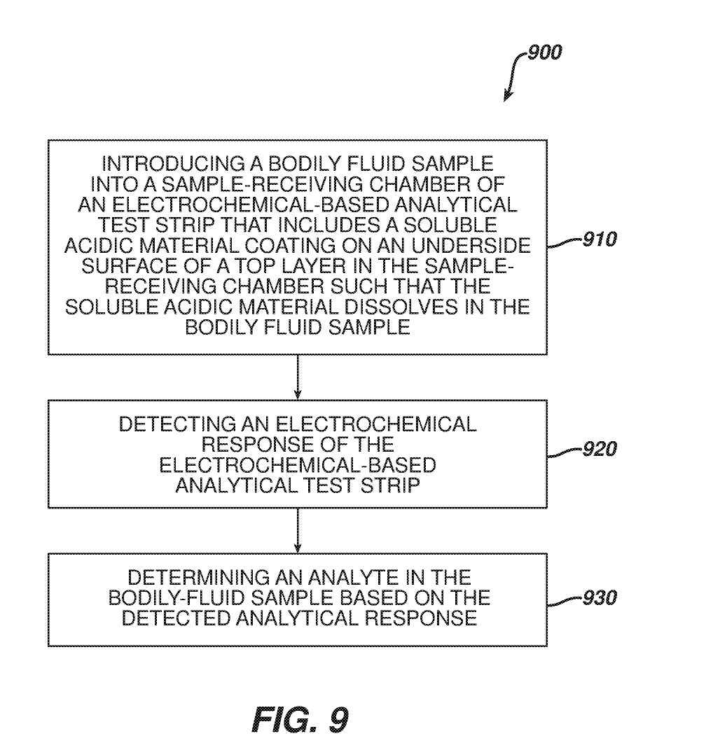

FIG. 9 is a flow diagram depicting stages in a method 900 for determining an analyte (such as glucose) in a bodily fluid sample (for example, a whole blood sample) according to an embodiment of the present invention. Method 900 includes, at step 910, introducing a bodily fluid sample into a sample-receiving chamber of an electrochemical-based analytical test strip with the electrochemical-based analytical test strip including a top layer with an underside surface and a soluble acidic material coating on the underside surface within at least a portion the sample-receiving chamber. The introduction of step 910 is such that the soluble acidic material coating operably dissolves in the bodily fluid sample and reduces a pH of the bodily fluid sample in the sample-receiving chamber.

At step 920 of method 900, an electrochemical response of the electrochemical-based analytical test strip is detected. In addition, at step 930 of FIG. 9 an analyte in the bodily fluid sample is determined based on the detected analytical response.

Once apprised of the present disclosure, one skilled in the art will recognize that method 900 can be readily modified to incorporate any of the techniques, benefits, features and characteristics of electrochemical-based analytical test strips according to embodiments of the present invention and described herein.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that devices and methods within the scope of these claims and their equivalents be covered thereby.

1.-29. (canceled)

30. An electrochemical-based analytical test strip for the determination of an analyte in a bodily fluid sample, the electrochemical-based analytical test strip comprising:
an electrically insulating base layer;
a patterned electrically conductive layer disposed on the electrically insulating base layer;
an enzymatic reagent layer disposed on at least a portion of the patterned electrically conductor layer;
a patterned spacer layer;
a top layer having an underside surface; and
a soluble acidic material coating on the underside surface of the top layer;
wherein at least the patterned spacer layer and top layer define a sample-receiving chamber within the electrochemical-based analytical test strip; and
wherein the soluble acidic material coating is disposed on the underside surface of the top layer within at least a portion the sample-receiving chamber; and
wherein the soluble acidic material coating is operably dissolvable in the bodily fluid sample such that a pH of the bodily fluid sample in the sample-receiving chamber is reduced during use of the electrochemical-based analytical test strip.

31. The electrochemical-based analytical test strip of claim 30 wherein the soluble acidic material coating includes a surfactant.

32. The electrochemical-based analytical test strip of claim 30 wherein the enzymatic reagent layer includes ferricyanide and the bodily fluid sample is a whole blood sample containing uric acid.

33. The electrochemical-based analytical test strip of claim 32 wherein the wherein the soluble acidic material coating is operably dissolvable in the bodily fluid sample such that a pH of the bodily fluid sample in the sample-receiving chamber is reduced to a pH in the range of pH 4 to pH 6 during use of the electrochemical-based analytical test strip.

34. The electrochemical-based analytical test strip of claim 32 wherein the wherein the soluble acidic material coating is operably dissolvable in the bodily fluid sample such that a pH of the bodily fluid sample in the sample-receiving chamber is reduced to a pH of approximately 4 during use of the electrochemical-based analytical test strip.

35. The electrochemical-based analytical test strip of claim 30 wherein the top layer, soluble acidic material layer are integrated as an engineered top tape.

36. The electrochemical-based analytical test strip of claim 30 wherein the patterned electrically conductive layer includes a plurality of electrodes disposed in the sample-receiving chamber.

37. The electrochemical-based analytical test strip of claim 30 wherein the analyte is glucose and the bodily fluid sample is a whole blood sample.

38. The electrochemical-based analytical test strip of claim 30 wherein the soluble acidic material coating includes citric acid.

39. The electrochemical-based analytical test strip of claim 38 wherein the soluble acidic material coating includes citric acid and tri-sodium citrate.

40. The electrochemical-based analytical test strip of claim 39 wherein the citric acid and tri-sodium citrate are formulated as a pH 4 buffer.

41. The electrochemical-based analytical test strip of claim 30 wherein the soluble acidic material coating and patterned electrically conductor layer are separated by a vertical distance of approximately 100 microns in the sample-receiving chamber.

42. The electrochemical-based analytical test strip of claim 41 wherein a thickness of the soluble acidic material coating is in the range of 5.8 microns to 17.3 microns.

43. The electrochemical-based analytical test strip of claim 30 wherein the soluble acidic material coating includes at least one of acetic acid, maleic acid, formic acid, and lactic acid.

44. The electrochemical-based analytical test strip of claim 30 wherein the electrically conductive layer includes at least one working electrode disposed in the sample-receiving chamber and the soluble acidic material coating is disposed in the sample-receiving chamber above the at least one working electrode.

45. A method for determining an analyte in a bodily fluid sample, the method comprising:
introducing a bodily fluid sample into a sample-receiving chamber of an electrochemical-based analytical test strip, the electrochemical-based analytical test strip including:
a top layer with an underside surface; and
a soluble acidic material coating on the underside surface within at least a portion the sample-receiving chamber, and
wherein the introduction is such that the soluble acidic material coating operably dissolves in the bodily fluid sample and reduces a pH of the bodily fluid sample in the sample-receiving chamber;
detecting an electrochemical response of the electrochemical-based analytical test strip; and
determining an analyte in the bodily fluid sample based on the detected analytical response.

46. The method of claim 45 wherein the electrochemical-based analytical test strip further includes:
an electrically insulating base layer;
a patterned electrically conductive layer disposed on the electrically insulating base layer;
an enzymatic reagent layer disposed on at least a portion of the patterned electrically conductor layer; and
a patterned spacer layer; and
wherein at least the patterned spacer layer and top layer defines the sample-receiving chamber within the electrochemical-based analytical test strip; and

[symbol]

47. The method of claim 46 wherein the detecting of an electrochemical response involves employing a plurality of electrodes of the patterned electrically conductive layer.

48. The method of claim 45 wherein the bodily fluid sample is a whole blood sample containing uric acid.

49. The method of claim 45 wherein the analyte is glucose.

50. The method of claim 45 wherein the soluble acidic material coating includes a surfactant.

51. The method of claim 45 wherein the enzymatic reagent layer includes ferricyanide and the bodily fluid sample is a whole blood sample containing uric acid.

52. The method of claim 45 wherein the wherein the soluble acidic material coating is dissolved in the bodily fluid sample such that a pH of the bodily fluid sample in the sample-receiving chamber is reduced to a pH in the range of pH 4 to pH 6.

53. The method of claim 45 wherein the soluble acidic material coating includes citric acid.

54. The method of claim 53 wherein the soluble acidic material coating includes citric acid and tri-sodium citrate.

55. The method of claim 54 wherein the citric acid and tri-sodium citrate are formulated as a pH 4 buffer.

56. The method of claim 45 wherein the soluble acidic material coating and patterned electrically conductor layer are separated by a vertical distance of approximately 100 microns in the sample-receiving chamber.

57. The method of clam 56 wherein a thickness of the soluble acidic material coating is in the range of 5.8 microns to 17.3 microns.

58. The method of claim 45 wherein the soluble acidic material coating includes at least one of acetic acid, maleic acid, formic acid, and lactic acid.
